(19) United States
(12) Patent Application Publication
(10) Pub. No.: US 2025/0192492 A1
(43) Pub. Date: Jun. 12, 2025

(54) TERMINAL ASSEMBLY

(71) Applicant: Caterpillar Inc., Peoria, IL (US)

(72) Inventors: Nikhilesh Solai, Coimbatore (IN); Saravanan Desigan, Chennai (IN); Sunil Pinnamaneni, Peoria, IL (US); Dean L. Kazubowski, Bradford, IL (US); Brad Lewis Beck, Peru, IL (US)

(73) Assignee: Caterpillar Inc., Peoria, IL (US)

(21) Appl. No.: 18/536,409

(22) Filed: Dec. 12, 2023

(51) Int. Cl. H01R 25/16; H01R 4/30; H01R 9/24; H01R 11/26

(52) U.S. Cl. CPC H01R 25/16; H01R 4/305; H01R 9/2416; H01R 11/26

(57) ABSTRACT

A terminal assembly for connecting a cable to a busbar includes a tubular body having a tubular portion disposed about a central axis and an annular end-wall. The tubular body defines an elongate recess configured to receive a free end of the cable therein. The terminal assembly also includes a fastener protruding outwardly from the annular end-wall. The fastener includes a first portion configured to be received within the tubular body and a second portion having a plurality of external threads thereon. The terminal assembly further includes a coupling member configured to couple the fastener with the busbar upon receipt of the second portion of the fastener within an opening in the busbar. The coupling member defining a plurality of internal threads that engage with the plurality of external threads on the second portion of the fastener to releasably secure the tubular body and the fastener with the busbar.

### TECHNICAL FIELD

The present disclosure relates to a system for creating an electrical junction and, more particularly, to a terminal assembly for connecting a cable to a busbar.

### BACKGROUND

Machines, such as off-highway trucks, track type tractors, or wheel dozers, include electric power systems or hybrid e.g., fuel-electric power systems that are used to provide power for propulsion, implement movement, or to perform other machine operations. Generally, such power systems include cables for electrically connecting at least two discrete components e.g., an electric motor, an inverter, a generator, or a power distribution unit. The cables may have a diameter that is thick enough to be usable for high-voltage applications. Conventional processes of assembling the cables with a component may be time consuming and may warrant considerable human effort. Moreover, an assembly time of the cable with the component may be dependent on an expertise of an assembly personnel, and a novice assembly personnel may require more time to assemble as compared to an experienced assembly personnel.

U.S. Pat. No. 10,128,615, hereinafter referred to as “the '615 patent”, describes a variable-clocking terminal assembly that includes a crimp barrel, a terminal lug, and a locking collar. The crimp barrel includes a crimp portion having a cavity sized and configured to receive a cable end of an electrical cable. The crimp barrel includes a conical portion extending axially from the crimp portion. The terminal lug has a cylindrical portion and a terminal tongue extending outwardly from the cylindrical portion. The cylindrical portion has a conical cavity configured complementary to the conical portion. The locking collar has collar threads configured to engage threads formed on one of the crimp barrel and the terminal lug for drawing the conical portion into direct physical engagement with the conical cavity in a manner locking an orientation of the terminal lug relative to the crimp barrel and establishing electrical continuity between the conical portion and the conical cavity.

However, the '615 patent also describes that the terminal tongue of the lug connects to a terminal block to form a planar connection therebetween. Owing to the planar connection between the tongue and the block, it becomes difficult to manipulate a cable esp., a thick cable, that may not be manipulated and diverted easily up to an extent that would allow the tongue to line up and connect with the block. In some cases, the cable may be so thick as to prevent routing, and in such cases, any twisting of the cable also would not permit the connection of the tongue to the block. Moreover, in the '615 patent, as the tongue of the lug is radially offset relative to a central axis of the cylindrical portion of the lug, such that the tongue that connects to the block is configured to revolve around the central axis, hence the name variable clocking terminal assembly.

The connection between the tongue and the block that, although allows clocking, is fixed in position during installation itself and has no flexibility to revolve during operation. Thus, it may be challenging to control an orientation of the tongue relative to the block. Further, the terminal assembly described in the '615 patent includes multiple mating parts, such as, the tongue, the cylindrical portion, the crimp barrel, and the locking collar that are coupled to each other to form the terminal assembly, thereby creating multiple electrical interfaces. Such multiple electrical interfaces created by the terminal assembly of the '615 patent may reduce a performance of the electrical connection established by the terminal assembly of the '615 patent.

### SUMMARY OF THE DISCLOSURE

In an aspect of the present disclosure, a terminal assembly for connecting a cable to a busbar is provided. The terminal assembly includes a tubular body having a tubular portion disposed about a central axis and an annular end-wall disposed proximal to one end of the tubular portion. The tubular body defining an elongate recess extending from another end of the tubular portion along the central axis. The elongate recess is configured to receive a free end of the cable therein. The terminal assembly also includes a fastener protruding outwardly from the annular end-wall of the tubular body. The fastener includes a first portion configured to be received within the tubular body. The fastener also includes a second portion having a plurality of external threads thereon. The second portion is configured to be received within an opening in the busbar. The terminal assembly further includes a coupling member configured to couple the fastener with the busbar upon receipt of the second portion of the fastener within the opening in the busbar. The coupling member defining a plurality of internal threads that engage with the plurality of external threads on the second portion of the fastener to releasably secure the tubular body and the fastener with the busbar.

In another aspect of the present disclosure, a system for creating an electrical junction is provided. The system includes a busbar defining an opening. The system also includes a cable having a free end. The system further includes a terminal assembly for connecting the cable to the busbar. The terminal assembly includes a tubular body having a tubular portion disposed about a central axis and an annular end-wall disposed proximal to one end of the tubular portion. The tubular body defining an elongate recess extending from another end of the tubular portion along the central axis. The elongate recess is configured to receive the free end of the cable therein. The terminal assembly also includes a fastener protruding outwardly from the annular end-wall of the tubular body. The fastener includes a first portion configured to be received within the tubular body. The fastener also includes a second portion having a plurality of external threads thereon. The second portion is configured to be received within the opening in the busbar. The terminal assembly further includes a coupling member configured to couple the fastener with the busbar upon receipt of the second portion of the fastener within the opening in the busbar. The coupling member defining a plurality of internal threads that engage with the plurality of external threads on the second portion of the fastener to releasably secure the tubular body and the fastener with the busbar.

The present disclosure is also directed to a machine having an electrical component and employing the terminal assembly disclosed herein.

Other features and aspects of this disclosure will be apparent from the following description and the accompanying drawings.

### BRIEF DESCRIPTION OF THE DRAWINGS

FIG. 1 is a schematic side view of an exemplary machine;

FIG. 2 is a block diagram of a drive system associated with the exemplary machine of FIG. 1;

FIG. 3 is a schematic perspective view of a system having a terminal assembly for creating an electrical junction associated with the exemplary machine of FIG. 1, according to an embodiment of the present disclosure;

FIG. 4A is a schematic cross-sectional view of a tubular body and a fastener of the terminal assembly of FIG. 3;

FIG. 4B is a schematic perspective view of the fastener of the terminal assembly of FIG. 3;

FIG. 5 is an exploded view of the system of FIG. 3;

FIG. 6 is a cross-sectional view of the system of FIG. 3;

FIG. 7A is a cross-sectional view illustrating a tubular body and a fastener that may be associated with the terminal assembly of FIG. 3, according to another embodiment of the present disclosure;

FIG. 7B is a schematic side view of an exemplary terminal assembly that may be associated with the system of FIG. 3;

FIG. 8 is a schematic perspective view illustrating another exemplary design of a busbar coupled to the terminal assembly described in conjunction with FIGS. 3 to 6;

FIG. 9 is a perspective view illustrating yet another exemplary design of a busbar coupled to the terminal assembly described in conjunction with FIGS. 3 to 6;

FIG. 10 is a schematic side view illustrating an exemplary system employing the terminal assembly described in conjunction with FIGS. 3 to 6; and

FIG. 11 is a schematic side view illustrating another exemplary system employing the terminal assembly described in conjunction with FIGS. 3 to 6.

### DETAILED DESCRIPTION

Wherever possible, the same reference numbers will be used throughout the drawings to refer to the same or like parts.

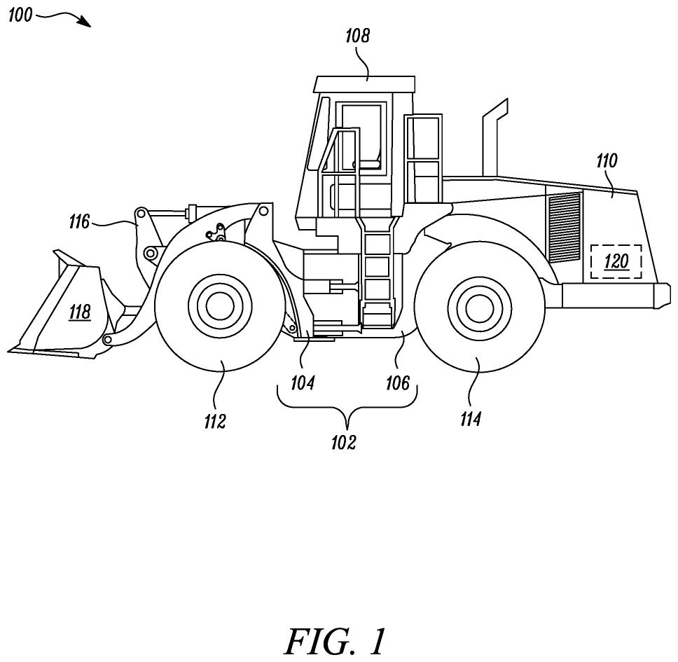

Referring to FIG. 1, a schematic side view of an exemplary machine 100 is illustrated. The machine 100 is embodied as a wheel loader that may be used for purposes, such as, but not limited to, construction, landscaping, or agriculture. Alternatively, the machine 100 may be embodied as an off-highway truck, a dozer, an excavator, a tractor, a motor grader, or a scraper, without any limitations, that may be used in various industries to move, remove, or load materials.

The machine 100 includes a frame 102. The frame 102 supports various components of the machine 100. The frame 102 includes a front frame 104 and a rear frame 106. The machine 100 also includes an operator cabin 108 supported by the rear frame 106. The machine 100 includes a hood 110 mounted on the rear frame 106. Further, the machine 100 includes a drive system 120 supported by the frame 102. The drive system 120 may include an electric drive system or a hybrid drive system. The hybrid drive system may include a combination of a fuel operated power source and electric components.

The frame 102 supports a pair of front wheels 112 and a pair of rear wheels 114. The front wheels 112 and the rear wheels 114 provide support and mobility to the machine 100 on grounds. Alternatively, the machine 100 may include tracks or drums instead of the front and rear wheels 112, 114.

The machine 100 also includes a linkage assembly 116. The linkage assembly 116 is movably coupled to the frame 102. The machine 100 further includes a work tool 118 movably coupled to the frame 102 via the linkage assembly 116. In the exemplary machine 100 of FIG. 1, the work tool 118 is shown embodied as a bucket that may be used for performing loading and unloading operations. In other examples, the work tool 118 may be any other type of work tool known in the art depending on specific machine type, configuration, or specific application requirements.

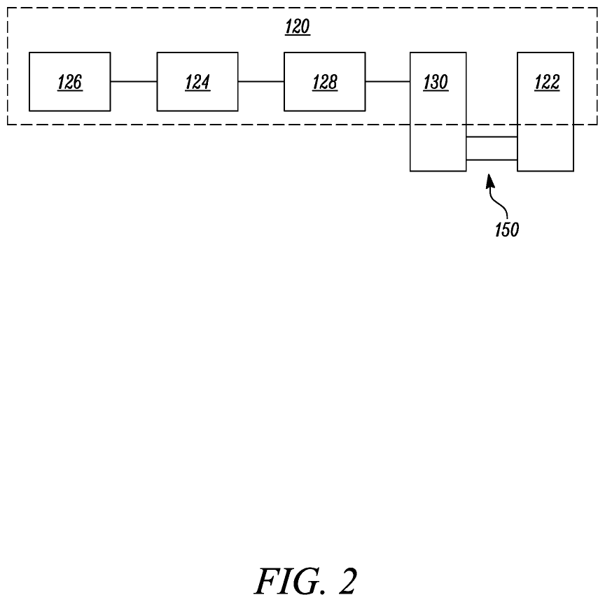

FIG. 2 illustrates a block diagram of the drive system 120 associated with the machine 100 of FIG. 1. The drive system 120 includes a motor 122, a generator 124, an engine 126, and a rectifier 128. In electric drive systems, the engine 126 may be replaced by a battery system (not shown). The machine 100 further includes an inverter 130. The inverter 130 forms a part of the drive system 120. The inverter 130 may allow the motor 122 to operate at variable speeds. The inverter 130 will hereinafter be referred to as “the electrical component” and denoted using identical reference numeral “130”.

The drive system 120 may provide power to various components of the machine 100 for operational and mobility requirements. In an example, the motor 122 may be embodied as a traction motor that may be used to move the front and rear wheels 112, 114 (see FIG. 1). The engine 126 may be an internal combustion engine. The engine 126 may produce an output torque to rotate a rotor (not shown) of the generator 124 to produce electrical power, for example, in the form of alternating current (AC) power. The electrical power may be supplied to the rectifier 128 and converted to direct current (DC) power. The rectified DC power may be converted again to AC power by the inverter 130. The machine 100 further includes a system 150. The system 150 electrically connects the inverter 130 and the motor 122.

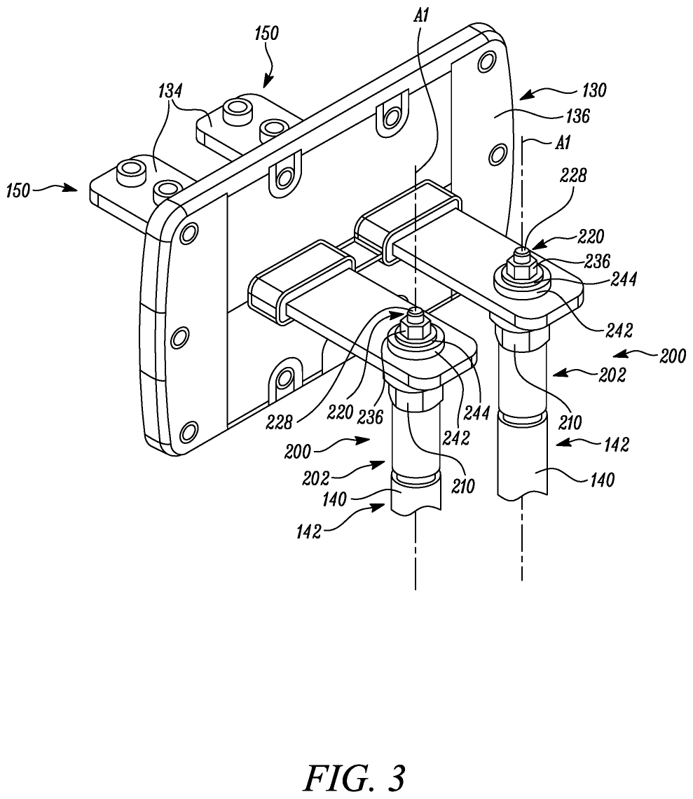

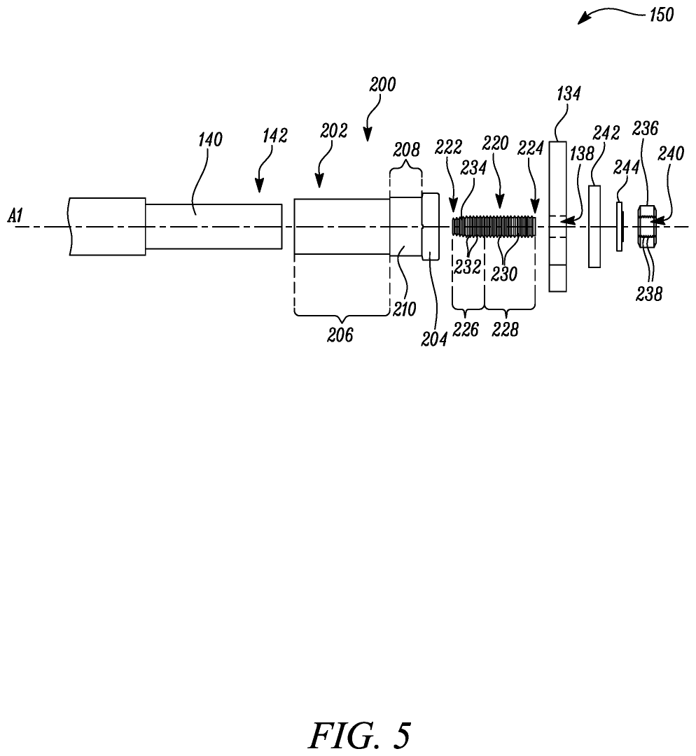

Referring to FIG. 3, the present disclosure relates to the system 150 for creating an electrical junction. The system 150 includes a busbar 134. FIG. 3 illustrates two busbars 134 that are identical to each other in terms of design and functionality. Further, the machine 100 includes the electrical component 130 and employs a terminal assembly 200. The busbar 134 is connected to the electrical component 130. The busbar 134 is fixedly connected to a terminal block 136 of the inverter 130. The busbar 134 is embodied as a flat rectangular plate herein. The busbar 134 defines an opening 138 (see FIG. 5). Although the system 150 connects the inverter 130 (see FIG. 2) with the motor 122 (see FIG. 2), the system 150 may be used to establish electrical connection between any two or more discrete components. Further, the terminal assembly 200 may be employed in battery systems, fuel cell systems, and the like.

The system 150 further includes a cable 140 having a free end 142. The free end 142 of the cable 140 is electrically connected with the busbar 134, via the terminal assembly 200. Further, another end (not shown) of the cable 140 is connected to the motor 122. The cable 140 may be thick enough to be usable in high-voltage applications for transmitting electrical power. Alternatively, the cable 140 may be usable in low-voltage applications or medium-voltage applications, as per application requirements. Further, the cable 140 includes a conductive core made of any material, such as, copper, and an insulation layer that surrounds the conductive core. The system 150 further includes the terminal assembly 200 for connecting the cable 140 with the busbar 134. FIG. 3 illustrates two terminal assemblies 200 that are identical to each other in terms of design and functionality.

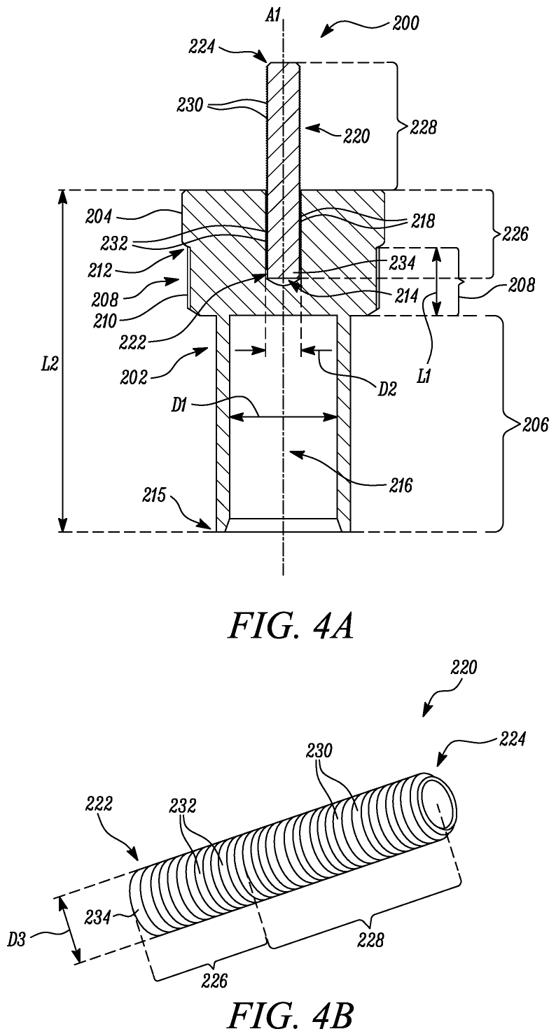

As shown in FIG. 4A, the terminal assembly 200 includes a tubular body 202. In one example, the tubular body 202 may be made from copper. Alternatively, the tubular body 202 may be made from any other metallic material. The tubular body 202 has a tubular portion 206 disposed about a central axis A1 and an annular end-wall 204 disposed proximal to one end 212 of the tubular portion 206.

The tubular body 202 further defines a means 208 to grip the tubular body 202 for securing a coupling member 236 to the fastener 220. Specifically, the means 208 is embodied as a tool engaging portion extending integrally between the annular end-wall 204 and the tubular portion 206. Thus, the means 208, the annular end-wall 204, and the tubular portion 206 are integrally formed, such that the tubular body 202 includes a one-piece design. Each of the annular end-wall 204, the tubular portion 206, and the means 208 extend along the central axis A1 and are disposed adjacent to each other.

Further, the means 208 includes a curvilinear outer surface 210. Specifically, the curvilinear outer surface 210 includes six tool engaging surfaces, such that the means 208 has a hexagonal cross-section (best visible in FIGS. 3, 8, and 9). Alternatively, the means 208 may define two, four, or eight tool engaging surfaces, without any limitations. The curvilinear outer surface 210 of the means 208 may contact a tool (not shown), such as, a spanner or a wrench during the coupling of the terminal assembly 200 with the busbar 134. In other examples, the curvilinear outer surface 210 may be replaced by a knurled outer surface. It should be noted that the means 208 may have any other design that may allow gripping of the tubular body 202.

Further, a length L1 of the means 208 to grip the tubular body 202 is less than or equal to a length L2 of the tubular body 202. In the illustrated embodiment of FIG. 4A, the length L1 of the means 208 is less than the length L2 of the tubular body 202. The length L1 may be sufficient enough to engage with the tool to grip the tubular body 202. In other examples, the length L1 of the means 208 may be equal to the length L2 of the tubular body 202, such that the curvilinear outer surface 210 extends along the entire length L2 of the tubular body 202.

The tubular body 202 defines an elongate recess 216 extending from another end 215 of the tubular portion 206 along the central axis A1. In the illustrated embodiment of FIG. 4A, the elongate recess 216 is defined by the tubular portion 206. The elongate recess 216 receives the free end 142 of the cable 140 therein. The free end 142 of the cable 140 is crimped with the tubular portion 206. The elongate recess 216 defines a first diameter D1. Further, the tubular body 202 defines an opening 214 extending from the annular end-wall 204 along the central axis A1, and a number of internal threads 218 adjacent to the opening 214 and radially disposed about the central axis A1. The opening 214 extends at least partially along the annular end-wall 204. In the illustrated embodiment of FIG. 4A, the opening 214 extends completely along the annular end-wall 204 and partially along the means 208 of the tubular portion 206. The opening 214 defines a second diameter D2. The first diameter D1 of the elongate recess 216 is greater than the second diameter D2 of the opening 214. Further, in the illustrated embodiment of FIG. 4A, the opening 214 and the elongate recess 216 are not in communication with each other. In other examples, the opening 214 may be embodied as a through-hole. In such examples, the opening 214 and the elongate recess 216 may be in communication with each other.

Referring to FIGS. 4A and 4B, the terminal assembly 200 also includes a fastener 220 protruding outwardly from the annular end-wall 204 of the tubular body 202. The fastener 220 is removably coupled to the tubular body 202. The fastener 220 includes a stud herein. It should be noted that the present disclosure in not limited by a type of the fastener 220, and the fastener 220 may include any other type and/or design. The fastener 220 defines a first end 222 and a second end 224 spaced apart from each other along the central axis A1. The fastener 220 defines a first portion 226 received within the tubular body 202. Specifically, the first portion 226 is received within the opening 214 in the tubular body 202. The first portion 226 extends from the first end 222 of the fastener 220. Further, the fastener 220 includes a second portion 228 having a number of external threads 230 thereon. The second portion 228 is received within the opening 138 (see FIG. 5) in the busbar 134 (see FIG. 5). The second portion 228 extends from the second end 224. The second portion 228 projects outward from the annular end-wall 204 of the tubular body 202.

Further, the first portion 226 of the fastener 220 also defines a number of external threads 232. The number of external threads 230 on the first portion 226 engage with the number of internal threads 218 on the tubular body 202 to removably couple the first portion 226 of the fastener 220 with the tubular body 202.

Further, the first portion 226 of the fastener 220 includes a taper portion 234 that is received within the opening 214. The taper portion 234 engages with the tubular body 202 to retain the fastener 220 within the tubular body 202. The taper portion 234 extends from the first end 222 of the tubular body 202, such that a maximum diameter D3 of the taper portion 234 is defined at the first end 222 of the fastener 220. In one example, the taper portion 234 may have a taper between 10 degrees to 15 degrees with respect to the central axis A1. In one specific example, the taper portion 234 may have a taper of 12.5 degrees with respect to the central axis A1.

Referring now to FIG. 5, the terminal assembly 200 includes the coupling member 236. The coupling member 236 couples the fastener 220 with the busbar 134 upon receipt of the second portion 228 of the fastener 220 within the opening 138 in the busbar 134. Specifically, the coupling member 236 removably couples the fastener 220 with the busbar 134. The coupling member 236 defines a number of internal threads 238 that engage with the number of external threads 230 of the second portion 228 of the fastener 220 to releasably secure the tubular body 202 and the fastener 220 with the busbar 134. Further, the coupling member 236 defines a through-hole 240. The through-hole 240 of the coupling member 236 aligns with the opening 138 in the busbar 134 to receive the second portion 228 of the fastener 220 to removably secure the tubular body 202 and the fastener 220 with the busbar 134. The coupling of the fastener 220 with the busbar 134 and the coupling member 236 establishes an electrical connection between the cable 140 and the busbar 134, via the terminal assembly 200.

In one example, the coupling member 236 may be made from steel. Alternatively, the coupling member 236 may be made from any other metallic material. Further, the coupling member 236 is a nut. The nut defines the plurality of internal threads 238. Specifically, the coupling member 236 is a hexagonal nut herein. Alternatively, the coupling member 236 may include a wing nut, or any other type of nut, based on application requirements. It should be noted that the coupling member 236 may include any other design that facilitates coupling of the fastener 220 with the busbar 134.

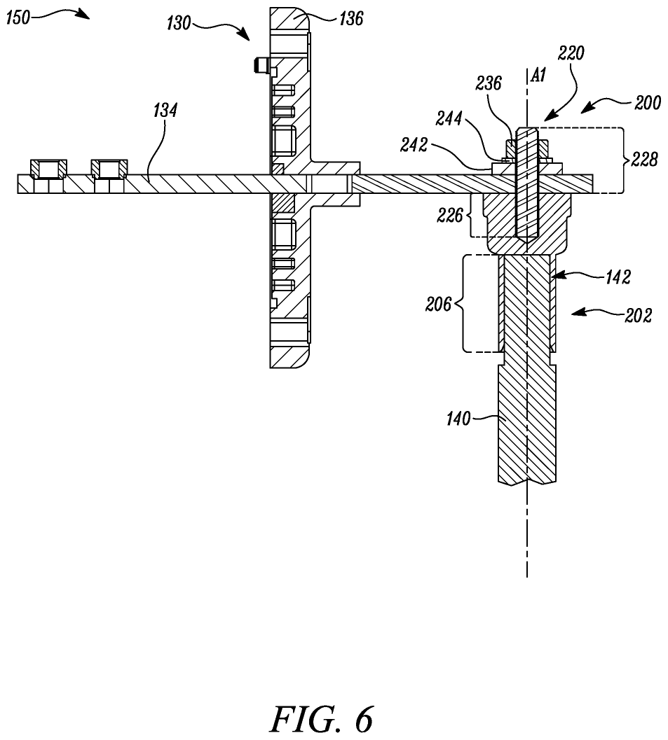

As shown in FIGS. 5 and 6, the terminal assembly 200 further includes one or more washers 242, 244. Upon receipt of the second portion 228 of the fastener 220 within the opening 138 in the busbar 134, the one or more washers 242, 244 surround the second portion 228 of the fastener 220. The one or more washers 242, 244 include the first washer 242. The washer 242 will hereinafter be referred to as “the first washer” and denoted using identical reference numeral “242”. Upon receipt of the second portion 228 of the fastener 220 within the opening 138 in the busbar 134, the first washer 242 surrounds the second portion 228 of the fastener 220 and is disposed adjacent to the busbar 134 along the central axis A1. The first washer 242 is embodied as a flat washer herein. Further, the one or more washers 242, 244 include the second washer 244. The washer 244 will hereinafter be referred to as “the second washer” and denoted using identical reference numeral “244”. Upon receipt of the second portion 228 of the fastener 220 within the opening 138 in the busbar 134, the second washer 244 surrounds the second portion 228 of the fastener 220 and is disposed adjacent to the first washer 242 along the central axis A1. The second washer 244 is embodied as a spring washer herein.

Referring now to FIG. 6, in order to establish the electrical connectivity between the cable 140 and the busbar 134, the cable 140 is crimped to the tubular portion 206 of the tubular body 202. Further, in order to couple the terminal assembly 200 with the busbar 134, the second portion 228 of the fastener 220 is passed through the opening 138 (see FIG. 5) in the busbar 134. Subsequently, the first and second washers 242, 244 are received within the fastener 220. Lastly, the coupling member 236 is threadedly engaged with the second portion 228 of the fastener 220, thereby coupling the terminal assembly 200 with the busbar 134. Specifically, the tubular body 202 is gripped by the tool and the coupling member 236 is torqued to the fastener 220 to removably couple the terminal assembly 200 with the busbar 134.

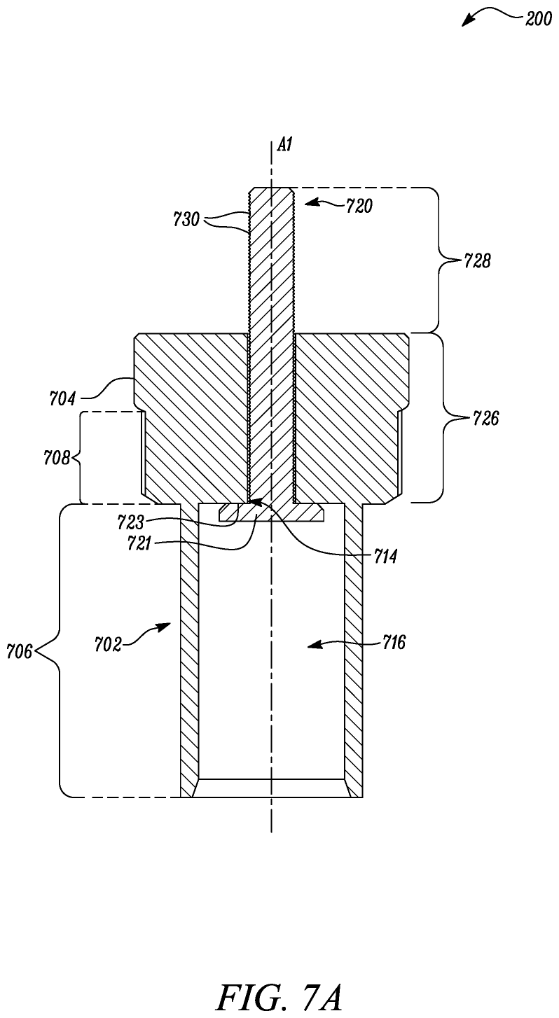

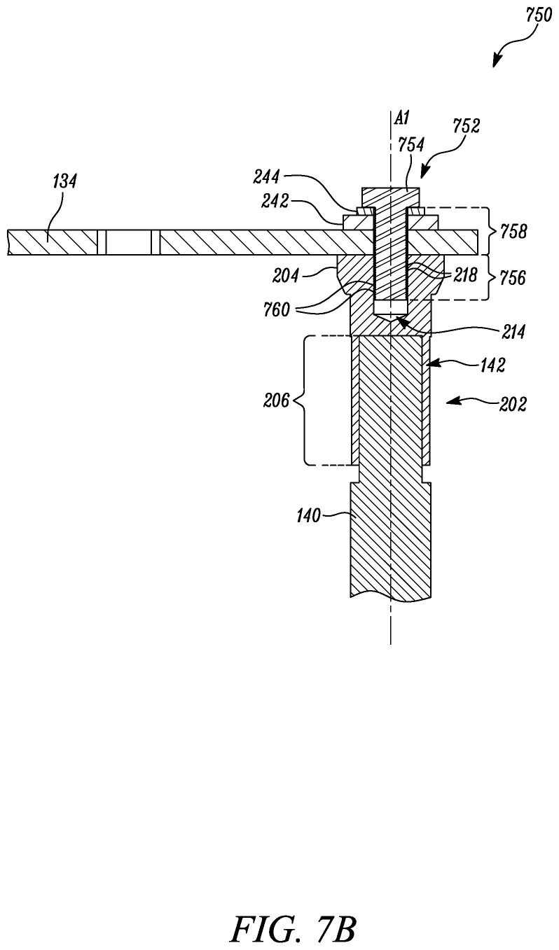

FIG. 7A illustrates another design for a tubular body 702 and a fastener 720 that may be associated with the terminal assembly 200 of FIGS. 3 to 6. The tubular body 702 is substantially similar to the tubular body 202 explained in conjunction with FIG. 4A. The tubular body 702 includes an annular end-wall 704, a means 708, and a tubular portion 706 similar to the annular end-wall 204, the means 208, and the tubular portion 206 shown and explained in conjunction with FIG. 4A. The tubular body 702 defines an opening 714 extending along the central axis A1. In the illustrated embodiment of FIG. 7A, the opening 714 extends completely along the annular end-wall 704. The tubular body 702 also defines an elongate recess 716 extending along the central axis A1. The elongate recess 716 is configured to receive the free end 142 of the cable 140 (see FIG. 3) therein. In the illustrated embodiment of FIG. 7A, the elongate recess 716 is defined by the tubular portion 706 and the means 708. Further, the elongated recess 716 and the opening 714 are in communication with each other.

Furthermore, in the illustrated embodiment of FIG. 7A, the fastener 720 is embodied as a stud. Alternatively, the fastener 720 may include a bolt, such as, a wheel rim bolt, a carriage bolt, and the like. The fastener 720 includes a head portion 721. The fastener 720 also includes a first portion 726 and a second portion 728. When the fastener 720 is coupled with the tubular body 702, the first portion 726 is received within the opening 714 in the tubular body 702. The first portion 726 may be coupled to the tubular body 702 via a press fit, an interference fit, and the like. Further, the first and second portions 726, 728 of the fastener 720 includes a number of external threads 730. The external threads 730 on the second portion 728 engage with the internal threads 238 (see FIG. 5) of the coupling member 236 (see FIG. 5) to releasably secure the tubular body 702 and the fastener 720 with the busbar 134 (see FIG. 3). During the coupling of the fastener 720 with the tubular body 702, the fastener 720 may be inserted into the opening 714 until the head portion 721 is in contact with a surface 723 of the tubular body 702.

FIG. 7B illustrates an exemplary terminal assembly 750 that may be associated with the system 150 of FIG. 3. The terminal assembly 750 includes the tubular body 202, the first washer 242, and the second washer 244 explained in conjunction with FIGS. 3 to 6. The terminal assembly 750 also includes a fastener 752. In the illustrated embodiment of FIG. 7B, the fastener 752 is embodied as a bolt. The fastener 752 includes a head portion 754. The fastener 752 also includes a first portion 756 and a second portion 758. The first portion 756 is received within the opening 214 in the tubular body 202. Further, the first and second portions 756, 758 of the fastener 752 includes a number of external threads 760. The external threads 760 of the second portion 758 engage with the internal threads 218 of the tubular body 202 to releasably secure the fastener 752 with the tubular body 202.

In order to establish the electrical connectivity between the cable 140 and the busbar 134 (see FIG. 3), the cable 140 is crimped to the tubular portion 206 of the tubular body 202. Further, to couple the terminal assembly 750 with the busbar 134, the fastener 752 is passed through the first and second washers 242, 244, and the opening 138 (see FIG. 5) in the busbar 134. Lastly, the fastener 752 is threadedly engaged with the tubular body 202, thereby coupling the terminal assembly 750 with the busbar 134. It should be noted that, when the fastener 752 is coupled with the tubular body 202, the head portion 754 is in contact with the second washer 244.

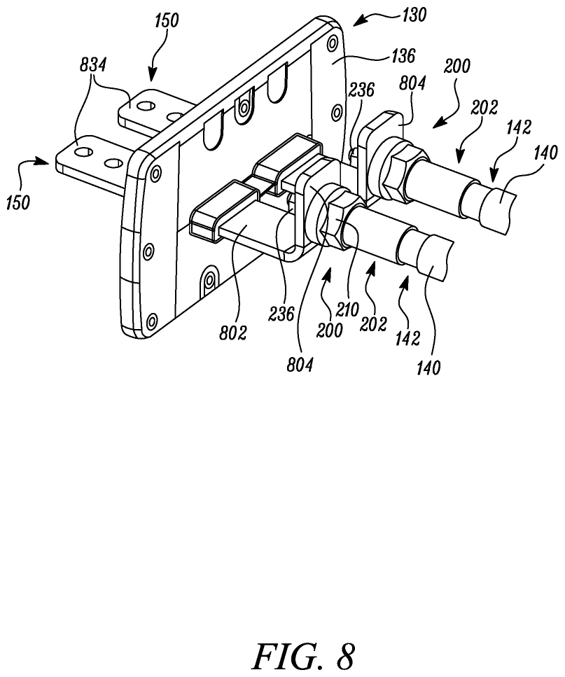

FIG. 8 illustrates another exemplary busbar 834. The busbar 834 includes a first section 802 and a second section 804 extending orthogonally from the first section 802. The first section 802 of the busbar 834 is coupled with the terminal block 136 of the inverter 130. Further, the second section 804 of the busbar 834 includes an opening (not shown) to receive the second portion 228 (see FIGS. 4A and 4B) of the fastener 220 (see FIGS. 4A and 4B). As shown in FIG. 8, the terminal assembly 200 is removably coupled to the busbar 834 to establish electrical connectivity between the cable 140 and the busbar 834. Specifically, the terminal assembly 200 is removably coupled to the second section 804 of the busbar 834.

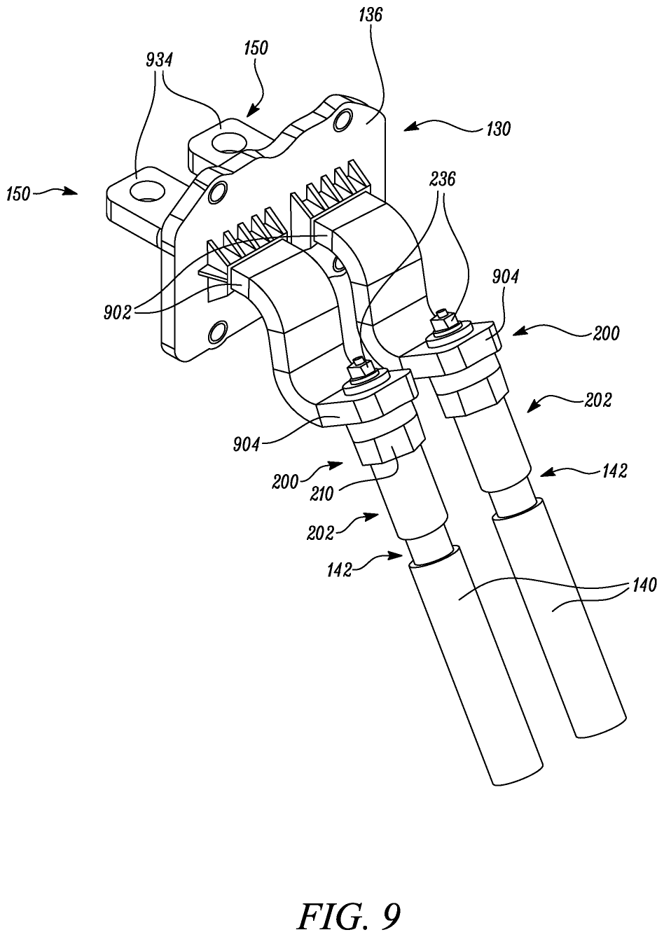

FIG. 9 illustrates yet another exemplary busbar 934. The busbar 934 includes a first section 902 and a second section 904 extending from the first section 902. The first section 902 of the busbar 934 is coupled with the terminal block 136 of the inverter 130. The second section 904 of the busbar 934 includes a curved profile. Further, the second section 904 of the busbar 934 includes an opening (not shown) to receive the second portion 228 (see FIGS. 4A and 4B) of the fastener 220 (see FIGS. 4A and 4B). As shown in FIG. 9, the terminal assembly 200 is removably coupled to the busbar 934 to establish electrical connectivity between the cable 140 and the busbar 934. Specifically, the terminal assembly 200 is removably coupled to the second section 904 of the busbar 934.

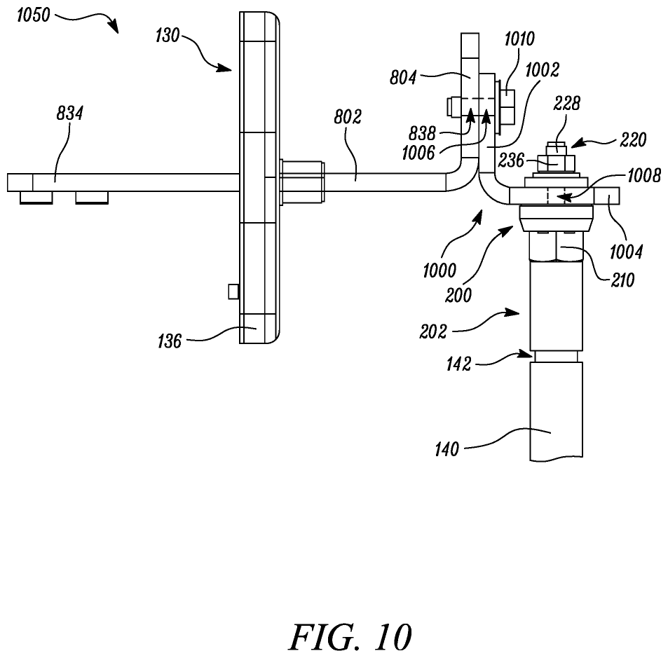

FIG. 10 illustrates a system 1050 having the terminal assembly 200 explained in conjunction with FIGS. 3 to 6, the busbar 834 explained in conjunction with FIG. 8, and the cable 140. As shown in FIG. 10, the terminal assembly 200 is removably coupled to the busbar 834 to establish electrical connectivity between the cable 140 and the busbar 834. The busbar 834 has the first section 802 and the second section 804 extending orthogonally from the first section 802. The first section 802 of the busbar 834 is coupled with the terminal block 136 of the inverter 130. Further, the second section 804 of the busbar 834 includes one or more openings 838. Specifically, the second section 804 includes the single opening 838 herein. The system 1050 further includes a bracket 1000. The terminal assembly 200 is coupled with the busbar 834 via the bracket 1000. The bracket 1000 includes an L-shaped design. The bracket 1000 includes a first portion 1002 and a second portion 1004. The first portion 1002 defines one or more first through-holes 1006 and the second portion 1004 defines a second through-hole 1008. Specifically, the first portion 1002 defines a single first through-hole 1006.

Further, the system 1050 includes a mechanical fastener 1010 that couples the bracket 1000 with the busbar 834. The opening 838 is in alignment with the first through-hole 1006 to receive the mechanical fastener 1010. Furthermore, the second through-hole 1008 of the bracket 1000 at least partially receives the second portion 228 of the fastener 220 to connect the terminal assembly 200 with the busbar 134.

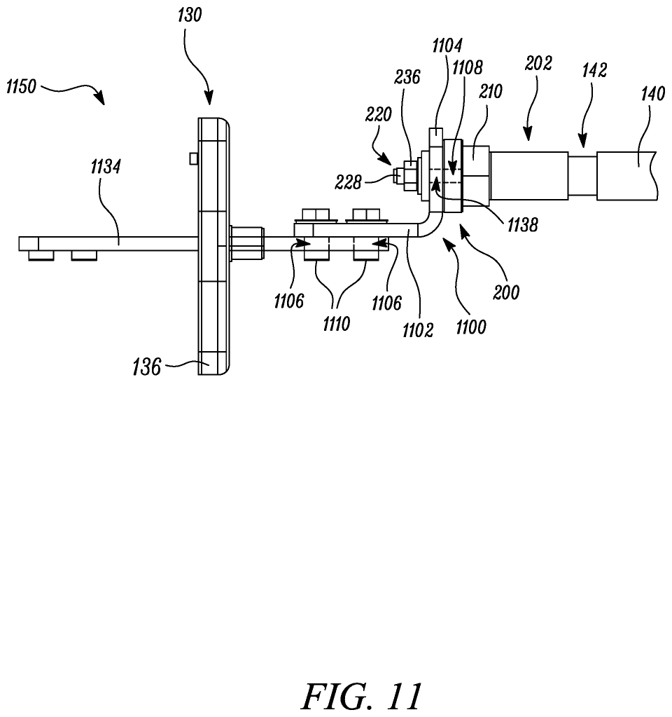

FIG. 11 illustrates a system 1150 having the terminal assembly 200 explained in conjunction with FIGS. 3 to 6, a busbar 1134, and the cable 140. As shown in FIG. 11, the terminal assembly 200 is removably coupled to the busbar 1134 to establish electrical connectivity between the cable 140 and the busbar 1134. The busbar 1134 is substantially similar to the busbar 134 shown and explained in conjunction with FIG. 3. The busbar 1134 includes one or more openings 1138. Specifically, the busbar 1134 includes two openings 1138 herein. The system 1150 further includes a bracket 1100. The terminal assembly 200 is coupled with the busbar 1134 via the bracket 1100. The bracket 1100 includes an L-shaped design. The bracket 1100 includes a first portion 1102 and a second portion 1104. The first portion 1102 defines one or more first through-holes 1106 and the second portion 1104 defines a second through-hole 1108. Specifically, the first portion 1102 defines a single first through-hole 1106.

Further, the system 1150 includes a pair of mechanical fasteners 1110 that couple the bracket 1100 with the busbar 1134. The openings 1138 are in alignment with corresponding first through-holes 1106 in the first portion 1102 to receive a corresponding mechanical fastener 1110. Furthermore, the second through-hole 1108 of the bracket 1100 at least partially receives the second portion 228 of the fastener 220 to connect the terminal assembly 200 with the busbar 134.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is directed towards the terminal assembly 200, 750 for electrically connecting the cable 140 with the busbar 134, 834, 934, 1134. The fastener 220, 720, 752 of the terminal assembly 200, 750 can be removably coupled with the busbar 134, 834, 934, 1134 and is rotatable about the central axis A1.

The terminal assembly 200, 750 of the present disclosure may allow rotation of the cable 140 relative to the busbar 134, 834, 934, 1134 in order to dispose the cable 140 in a desired orientation, prior to installation, without requiring specialized tools and fixtures. The tubular body 202, 702 of the terminal assembly 200, 750 connects with the cable 140. The cable 140 may include, for example, a high-voltage conductor cable. The terminal assembly 200, 750 may act as an orientation-free interface and may accommodate twists on the cable 140 by making a pinned electrical connection over a planar connection as observed in conventional terminal assemblies. The tubular body 202, 702 of the terminal assembly 200, 750 includes a simple and one-piece design, and may be easy to handle.

Further, the fastener 220 includes the taper portion 234 formed at the first portion 226 which provides a locking mechanism that prevents removal of the fastener 220 from the tubular body 202, while the coupling member 236 is being removed from the fastener 220.

Further, the terminal assembly 200, 750 may eliminate a requirement of specialized and heavy tools/fixtures for connecting the cable 140 with the busbar 134, 834, 934, 1134. The terminal assembly 200, 750 may also simplify a process of connecting the cable 140 with the busbar 134, 834, 934, 1134, while significantly reducing assembly time and overall costs associated with the system 150, 1050, 1150. Further, the terminal assembly 200, 750 may be used across various machines. Overall, the terminal assembly 200, 750, when compared to conventional terminal assemblies, may be cost-effective, may include fewer parts, may be retrofitted on existing machines, may be easy to handle, and may have a simple design.

The terminal assembly 200, 750 also provides a high performance electrical connection by providing a good surface finish, fewer electrical interfaces due to fewer mating parts, higher electrical contact area, and higher contact pressure. Moreover, the same design of the terminal assembly 200, 750 may be used for the busbar 134 as shown in FIGS. 3 and 6, or for different designs of the busbars 834, 934, as shown in FIGS. 8 and 9, respectively.

The terminal assembly 200, 750 may have a compact package size which may facilitate improved serviceability. Further, due to the compact size of the terminal assembly 200, 750, the terminal assembly 200, 750 may be easy to accommodate in compact workspaces. The terminal assembly 200, 750 may also provide a reliable electrical connection due to the robust mechanical connection between the components of the terminal assembly 200, 750.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of the disclosure. Such embodiments should be understood to fall within the scope of the present disclosure as determined based upon the claims and any equivalents thereof.

What is claimed is:

1. A terminal assembly for connecting a cable to a busbar, the terminal assembly comprising:
a tubular body having a tubular portion disposed about a central axis and an annular end-wall disposed proximal to one end of the tubular portion, the tubular body defining an elongate recess extending from another end of the tubular portion along the central axis, the elongate recess is configured to receive a free end of the cable therein; and
a fastener protruding outwardly from the annular end-wall of the tubular body, wherein the fastener includes:
a first portion configured to be received within the tubular body; and
a second portion having a plurality of external threads thereon, the second portion is configured to be received within an opening in the busbar.

2. The terminal assembly of claim 1 further comprising a coupling member configured to couple the fastener with the busbar upon receipt of the second portion of the fastener within the opening in the busbar, the coupling member defining a plurality of internal threads that engage with the plurality of external threads on the second portion of the fastener to releasably secure the tubular body and the fastener with the busbar.

3. The terminal assembly of claim 2, wherein the coupling member is a nut.

4. The terminal assembly of claim 2, wherein the tubular body defines a means to grip the tubular body for securing the coupling member to the fastener.

5. The terminal assembly of claim 4, wherein a length of the means to grip the tubular body is less than or equal to a length of the tubular body.

6. The terminal assembly of claim 1, wherein the tubular body defines an opening extending from the annular end-wall along the central axis, and a plurality of internal threads adjacent to the opening and radially disposed about the central axis.

7. The terminal assembly of claim 6, wherein the first portion of the fastener defines a plurality of external threads, and wherein the plurality of external threads on the first portion engage with the plurality of internal threads on the tubular body to removably couple the first portion of the fastener with the tubular body.

8. The terminal assembly of claim 6, wherein the first portion of the fastener includes a taper portion that is received within the opening, and wherein the taper portion engages with the tubular body to retain the fastener within the tubular body.

9. The terminal assembly of claim 6, wherein a first diameter of the elongate recess is greater than a second diameter of the opening.

10. The terminal assembly of claim 6, wherein the opening extends at least partially along the annular end-wall.

11. The terminal assembly of claim 6, wherein the elongate recess and the opening are in communication with each other.

12. The terminal assembly of claim 1 further comprising at least one washer, wherein, upon receipt of the second portion of the fastener within the opening in the busbar, the at least one washer surrounds the second portion of the fastener.

13. The terminal assembly of claim 1, wherein the fastener includes any one of a stud and a bolt.

14. A machine comprising:
an electrical component and employing the terminal assembly of claim 1.

15. A system for creating an electrical junction, the system comprising:
a busbar defining an opening;
a cable having a free end; and
a terminal assembly for connecting the cable to the busbar, the terminal assembly including:
a tubular body having a tubular portion disposed about a central axis and an annular end-wall disposed proximal to one end of the tubular portion, the tubular body defining an elongate recess extending from another end of the tubular portion along the central axis, the elongate recess is configured to receive the free end of the cable therein; and
a fastener protruding outwardly from the annular end-wall of the tubular body, wherein the fastener includes:
a first portion configured to be received within the tubular body; and
a second portion having a plurality of external threads thereon, the second portion is configured to be received within the opening in the busbar.

16. The system of claim 15, wherein the terminal assembly includes a coupling member configured to couple the fastener with the busbar upon receipt of the second portion of the fastener within the opening in the busbar, the coupling member defining a plurality of internal threads that engage with the plurality of external threads on the second portion of the fastener to releasably secure the tubular body and the fastener with the busbar.

17. The system of claim 16, wherein the tubular body defines a means to grip the tubular body for securing the coupling member to the fastener.

18. The system of claim 15, wherein the tubular body defines an opening extending from the annular end-wall along the central axis, and a plurality of internal threads adjacent to the opening and radially disposed about the central axis.

19. The system of claim 18, wherein the first portion of the fastener defines a plurality of external threads, and wherein the plurality of external threads on the first portion engage with the plurality of internal threads on the tubular body to removably couple the first portion of the fastener with the tubular body.

20. The system of claim 18, wherein a first diameter of the elongate recess is greater than a second diameter of the opening.
